(19) United States
(12) Patent Application Publication
(10) Pub. No.: US 2013/0306751 A1
(43) Pub. Date: Nov. 21, 2013

(54) CLIP-ON DEVICE FOR REPELLING GNATS

(71) Applicant: CARL DOUGLAS HAYES, III, SIILVER SPRING, MD (US)

(72) Inventor: CARL DOUGLAS HAYES, III, SIILVER SPRING, MD (US)

(21) Appl. No.: 13/889,315

(22) Filed: May 7, 2013

Related U.S. Application Data
(60) Provisional application No. 61/649,678, filed on May 21, 2012.

(51) Int. Cl. A01M 29/12

(52) U.S. Cl. CPC A01M 29/12
USPC 239/36

(57) ABSTRACT

The clip-on device for repelling gnats is easily attached to a belt or the like. The device includes a container for housing an absorbent material therein. The absorbent material is infused with a formulation that will emit a scent that repels gnats. The formulation is non-toxic to humans. The container includes a closable opening for inserting the absorbent material therein. Vents are provided in the top of the container to emitting the scented flow via non-motorized, natural convection.

### CROSS-REFERENCE TO RELATED APPLICATION

This application claims the benefit of U.S. Provisional Patent Application Ser. No. 61/649,678, filed May 21, 2012.

### BACKGROUND OF THE INVENTION

1. Field of the Invention

The present invention relates to pest repellant devices, and particularly to a clip-on device for repelling gnats.

2. Description of the Related Art

A peaceful walk in the park, an enjoyable cookout on the patio, or a restful lounge by the backyard pool can all be ruined by an invasion of flying insects, particularly gnats. An entire industry has developed and is dedicated to finding and marketing products and apparatus to repel these infernal pests. Many of these products require that the repellant be applied directly to the skin. This scenario often results in leaving undesired aromas on the skin and clothing. In many instances the repellant can contain toxic materials, which would render it unsafe for users, and especially children. Expensive “zap” machines are somewhat effective against mosquitoes, but are ineffective in controlling gnats. Some clip-on devices are available that are motorized and utilize miniature fans to disperse the repellent, thereby adding the cost of continuing battery purchases. Again, these devices have proven to be ineffectual for controlling gnats. The pest control industry would certainly welcome an inexpensive device that could be easily used by adults and children to effectively banish swarming gnats and make the outdoor experience more enjoyable. Thus, a clip-on device for repelling gnats solving the aforementioned problems is desired.

### SUMMARY OF THE INVENTION

The present invention is a clip-on device for repelling gnats that is easily attached to a belt or the like. The device comprises a container for housing an absorbent material therein. The absorbent material is infused with a formula that will emit a scent that repels gnats. The formula is non-toxic to humans. The container includes a re-closable opening for inserting the absorbent material therein. Vents are provided in the top of the container for emitting the scented flow via non-motorized, natural convection.

Accordingly, the invention presents a device that is highly effective in repelling gnats. The device is adapted for use in close proximity to a user's body and includes means for attaching the device adjacent to the user's body. The invention provides for improved elements thereof in an arrangement for the purposes described that are inexpensive, dependable and fully effective in accomplishing their intended purposes.

These and other features of the present invention will become readily apparent upon further review of the following specification and drawings.

### BRIEF DESCRIPTION OF THE DRAWINGS

FIG. 1 is an environmental, perspective view of a clip-on device for repelling gnats according to the present invention.

FIG. 2 is an exploded, front view of a clip-on device for repelling gnats according to the present invention.

FIG. 3 is a side view of a clip-on device for repelling gnats according to the present invention.

Similar reference characters denote corresponding features consistently throughout the attached drawings.

### DETAILED DESCRIPTION OF THE PREFERRED EMBODIMENTS

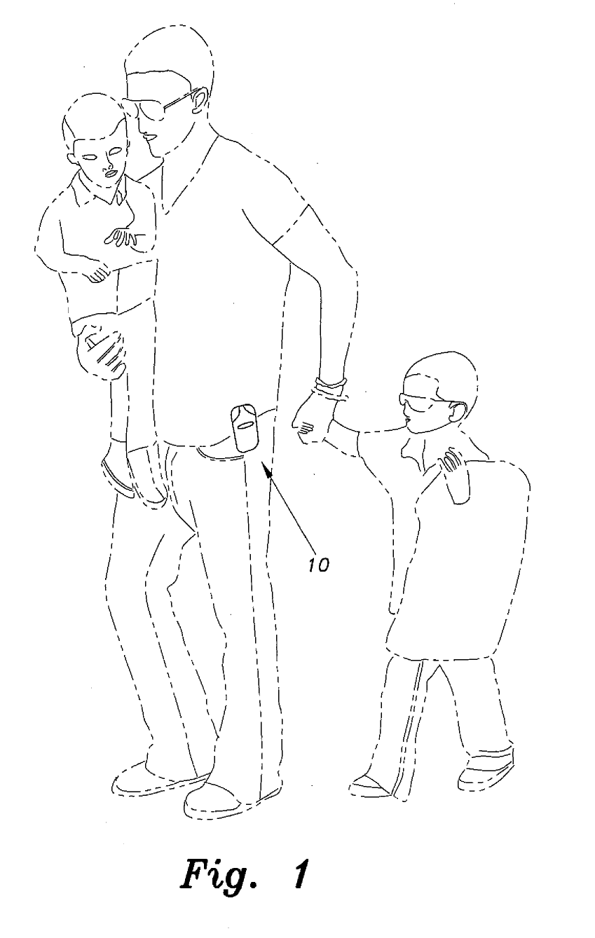

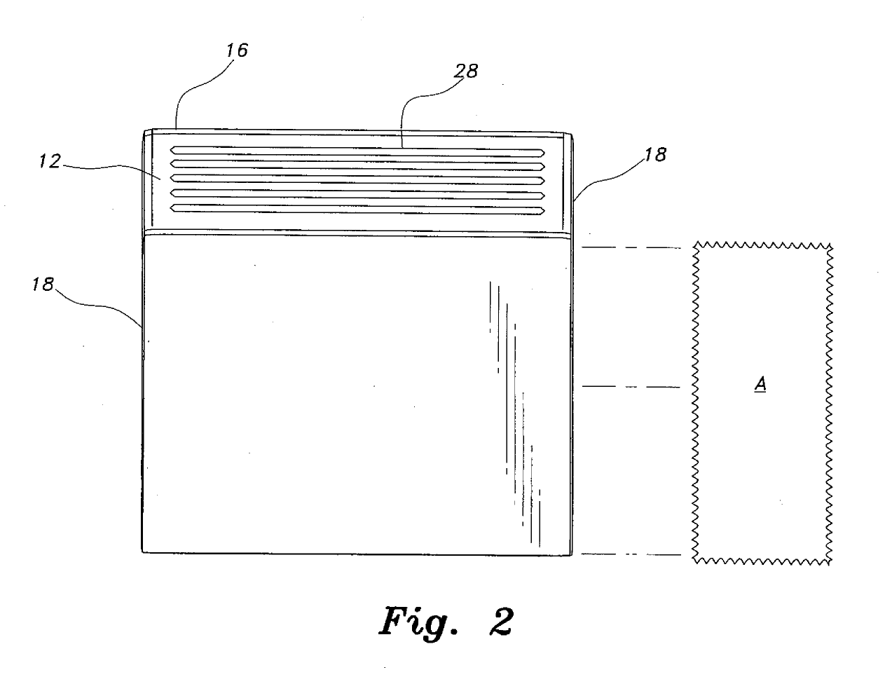

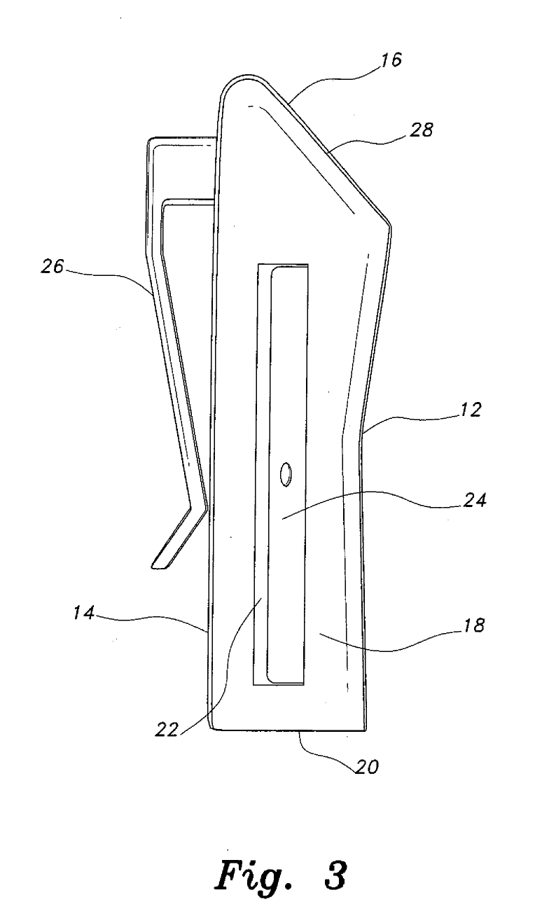

Referring to FIGS. 1-3, the clip-on device for repelling gnats is generally indicated at 10 and comprises a container having a front wall 12, a rear wall 14, a top wall 16, sidewalls 18, and a bottom wall 20 that define a chamber. The device 10 may be fabricated from any suitable material, e.g., plastic, that is capable of retaining at least a semi-rigid configuration. An access opening 22 is provided in one of the sidewalls 18. A sliding door 24 is adapted to optionally close the access opening 22. Other types of closure members (flaps, hinged door, etc.) may be utilized, if desired. The opening 22 is dimensioned to receive an insert A that is placed in the container. The insert A is an absorbent material infused with a formulation that will repel insects, and especially gnats. The insert A is not limited to infused, absorbent material, but may take on other forms, such as a gel insert or a cartridge. A clip 26 is positioned on the rear wall 14 for attaching the device 10 to a belt, a pocket, or the like. A plurality of vent openings 28 is disposed through the top wall 16, which may be canted or sloped, as shown in the drawings.

As indicated above, the device 10 is easy to use, requiring only that the insert A be infused with a proper gnat repellant formulation and inserted into the device 10. A repellant formulation comprising a combination of pure vanilla extract and water in a 50/50 mixture is preferred and has proven to be highly effective in repelling gnats. It should be noted that other mixture proportions may also be effective. The scent of the repellant will diffuse to the atmosphere surrounding the container through the vent openings 28 via natural convection.

It is to be understood that the present invention is not limited to the embodiments described above, but encompasses any and all embodiments within the scope of the following claims.

I claim:

1. A clip-on device for repelling gnats, comprising:
a container having a front wall, a rear wall, a bottom wall, a top wall and two sidewalls defining an enclosed chamber, at least one of the walls having a plurality of vent openings defined therein, and at least one of the walls having a re-closable access opening defined therein;
a clip member positioned on one of the walls; and
an insert infused with a gnat repellent material, the insert being removably disposed in the chamber.

2. The clip-on device for repelling gnats according to claim 1, wherein the plurality of vent openings are positioned in said top wall,

3. The clip-on device for repelling gnats according to claim 1, wherein the re-closable access opening is positioned in one of said sidewalls.

4. The clip-on device for repelling gnats according to claim 1, wherein the clip member is positioned on said rear wall.

5. The clip-on device for repelling gnats according to claim 1, further including a closure member for optionally closing the access opening.

6. The clip-on device for repelling gnats according to claim 1, wherein said gnat repellant material is a combination of pure vanilla extract and water.

7. A clip-on device for repelling gnats, comprising:
a container having a front wall, a rear wall, a bottom wall, a top wall and two sidewalls defining an enclosed chamber, the top wall having a plurality of vent openings defined therein, one of the sidewalls having a re-closable access opening defined therein;
a clip member positioned on the rear wall; and
an absorbent insert infused with a gnat repellent material, the absorbent insert being removably disposed in the chamber.

8. The clip-on device for repelling gnats according to claim 7, further including a closure member for optionally closing the access opening.

9. The clip-on device for repelling gnats according to claim 7, wherein said gnat repellant material is a combination of pure vanilla extract and water.

10. A clip-on device for repelling gnats, comprising:
a container having a front wall, a rear wall, a bottom wall, a top wall and two sidewalls defining an enclosed chamber the top wall having a plurality of vent openings defined therein, one of the sidewalls having a re-closable access opening defined therein;
a closure member for optionally closing the access opening;
a clip member positioned on the rear wall; and
an absorbent insert infused with a 50/50 mixture of pure vanilla extract and water, the absorbent insert being removably disposed in the chamber.
